(19) United States
(12) Patent Application Publication
(10) Pub. No.: US 2005/0090932 A1
(43) Pub. Date: Apr. 28, 2005

(54) Apparatus for processing preliminary products in the graphics industry

(75) Inventors: Markus Belmann, Kornwestheim/Pattonville (DE); Bernd Kernstock, Ludwigsburg (DE); Klaus-Peter Schreiber, Asperg (DE)

Correspondence Address: LERNER AND GREENBERG, PA, P O BOX 2480, HOLLYWOOD, FL, 33022-2480, US

(73) Assignee: Heidelberger Druckmaschinen Aktiengesellschaft

(21) Appl. No.: 10/974,435

(22) Filed: Oct. 27, 2004

Related U.S. Application Data
(60) Provisional application No. 60/516,154, filed on Oct. 31, 2003.

(30) Foreign Application Priority Data
Oct. 27, 2003 (DE) 103 50 095.2

(51) Int. Cl. G06F 7/00; F26B 5/04

(52) U.S. Cl. 700/230

(57) ABSTRACT

An apparatus for processing preliminary products in the graphics industry with the preliminary products at a standstill in a processing position, includes a conveyor by which the preliminary products can be transported in a transporting direction, along a transporting section, into the processing position, a drive that operates the conveyor, a detector that detects a respective preliminary product en route along the transporting section, and a controller that is linked up with the detector and the drive and by which the drive can be brought to a temporary standstill when the respective preliminary product reaches the processing position. On account of stops not being present, the preliminary products remain intact at least along their leading edges, as seen in the transporting direction, there are no marks on these edges, and the set-up times during a changeover of the format of the preliminary products are relatively short.

The invention relates to an apparatus for processing preliminary products in the graphics industry. The preliminary products include, for example, printed sheets of paper or paperboard which, depending on the degree of completion, have not been folded or have at least one fold. Processing of such preliminary products may involve, for example, providing a fold.

An apparatus for processing preliminary products in the graphics industry by folding is known, for example, from DE 693 08 075 T2. This document discloses a buckle folder. The latter applies, in the first instance, parallel first folds to preliminary products in the form of paper sheets. The resulting signatures are transported in a transporting direction, transverse to the direction of the first folds, by means of a first conveyor until the respective signature reaches a stop which stops it temporarily, to be precise until such time as circulating carry-along elements of a second conveyor, which transports transversely to the transporting direction of the first conveyor, reach a side of the signature and convey the same in the direction of a folding station, in which the signature is provided with a further fold, perpendicular to the first folds. Each of the two conveyors comprises a belt drive, which will not be discussed in any more detail. From the functioning of the known apparatus, however, it can be gathered that the two conveyors are driven on a constant basis during operation, and that the conveyors transport the signatures at the production speed. This results in severe impact of a respective signature against the said stop. The associated action of the signatures rebounding from this stop is intended to be counteracted, in the case of the known apparatus, by means of a brush, the bristles of which tend to be oriented in the direction of the stop and pass over the signatures as they travel in the direction of the stop. DE 198 60 070 A1 discloses a further apparatus for processing preliminary products in the graphics industry. This known apparatus is a buckle folding unit with an adjustable stop, of which the position in relation to a buckle plate determines the position of the fold on the preliminary product, which, once again, is present in the form of a sheet. The stop can be adjusted by means of an electrically activatable adjusting device which can be actuated by a control unit. For corresponding actuation of the adjusting device, the control unit processes signals from at least one detector which, for the purpose of generating these signals, detects a respective sheet as it runs into the buckle plate and as it runs out of the same.

Whereas the stops constitute necessary functional parts of buckle folding units, stops against which sheets or signatures strike once they have passed through a transporting section otherwise prove to be disadvantageous in a number of ways. On the one hand, as can be seen from the abovementioned DE 693 08 075 T2, measures have to be taken in order to prevent the preliminary products from rebounding from the stops and, on the other hand, there is a risk of the preliminary products being damaged.

The object of the invention is for an apparatus for processing preliminary products in the graphics industry with the preliminary products at a standstill in a processing position, having a conveyor which transports the preliminary products into the processing position, to be configured such that stops which act on the preliminary products in order to stop the same can be dispensed with.

This object is achieved according to the invention by an apparatus for processing preliminary products in the graphics industry with the preliminary products at a standstill in a processing position, having a conveyor by means of which the preliminary products can be transported in a transporting direction, along a transporting section, into the processing position, having a drive which operates the conveyor, having a detector which detects a respective preliminary product en route along the transporting section, and having a control means which is linked up with the detector and the drive and by means of which the drive can be brought to a temporary standstill when the respective preliminary product reaches the processing position.

On account of stops not being present, the preliminary products remain intact at least along their leading edges, as seen in the transporting direction, there are no marks on these edges, and the set-up times during a changeover of the format of the preliminary products are relatively short. It is thus the case that the conveyor, on account of the drive being at a standstill when the preliminary product is located in the processing position, does not leave behind any scuff marks on this preliminary product.

An advantageous development provides that the control means brings the drive to a standstill if a preliminary product which reaches the processing station has a geometry which lies within predetermined limits. This allows incorrect preliminary products to be rejected without being processed in the processing station.

If the apparatus, in the case of a preferred configuration, comprises a right-angle folding unit for applying a longitudinal fold to a preliminary product in the form of a sheet provided with at least one cross fold, then the detector and the control means linked up to the latter and the drive make possible a completely automatic folding process which, in the case of one configuration of the apparatus according to the abovementioned development, provides only correctly pre-folded signatures with a right-angle fold and rejects incorrectly pre-folded signatures.

The features of the invention can be gathered from the drawings and the related explanation of the abovementioned preferred configuration with a processing station in the form of a right-angle folding unit.

In the drawings:

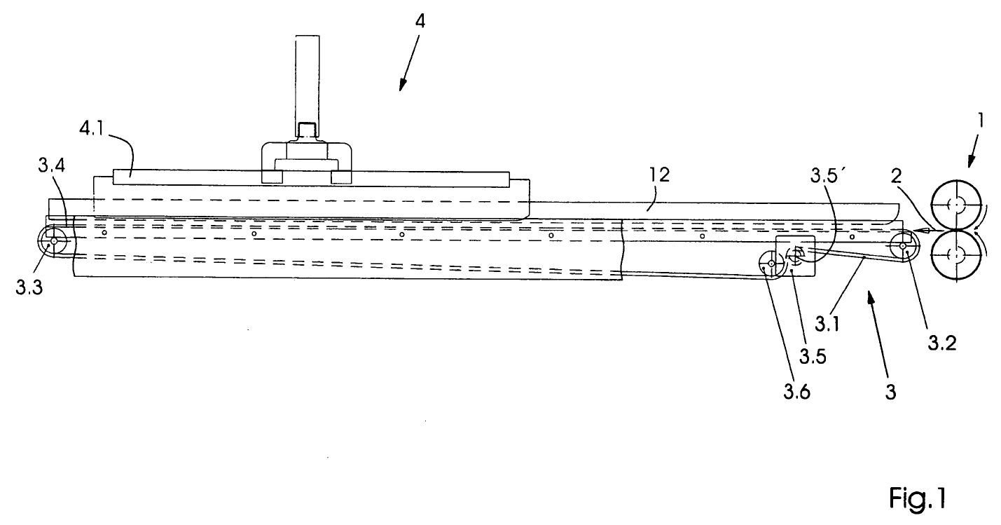

FIG. 1 shows a schematically illustrated side view of a processing station in the form of a right-angle folding unit, only a folding blade, from among the folding tools of this folding unit, being represented, of a pair of folding rollers arranged upstream of the right-angle folding unit, and of a conveyor which comprises toothed belts and transports signatures along a transporting section, into a processing position for the purpose of providing a right-angle fold,

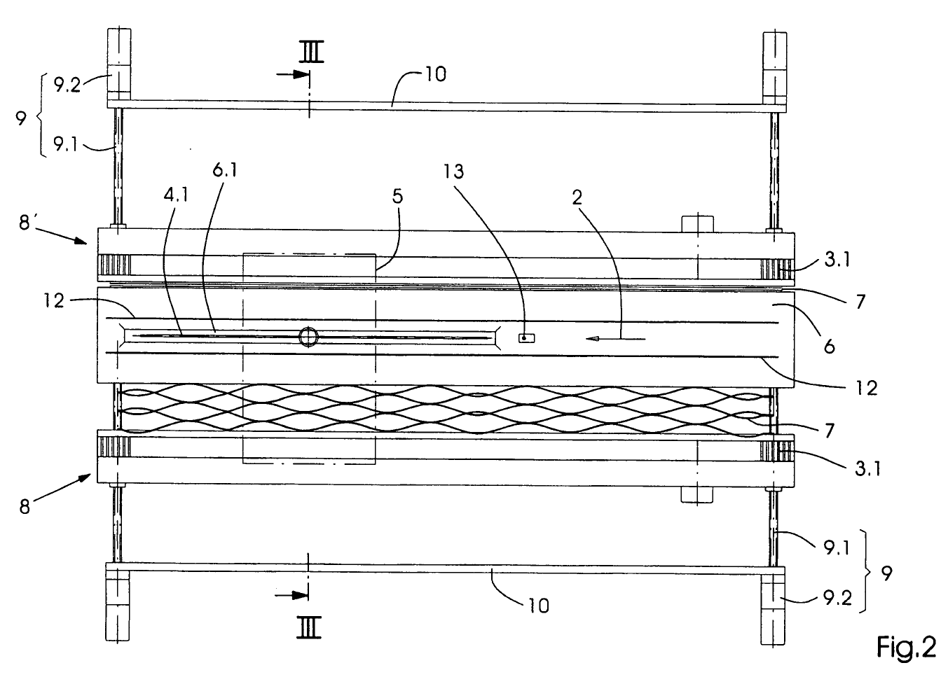

FIG. 2 shows a schematically illustrated plan view of the right-angle folding unit, the conveyor and adjusting units for adjusting the conveyor to a respective format of the signatures,

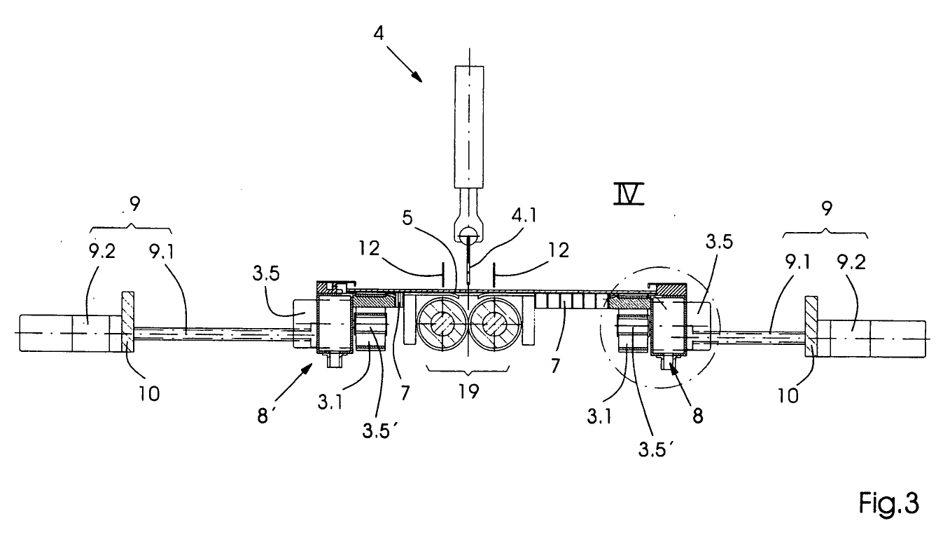

FIG. 3 shows a section along line III in FIG. 2,

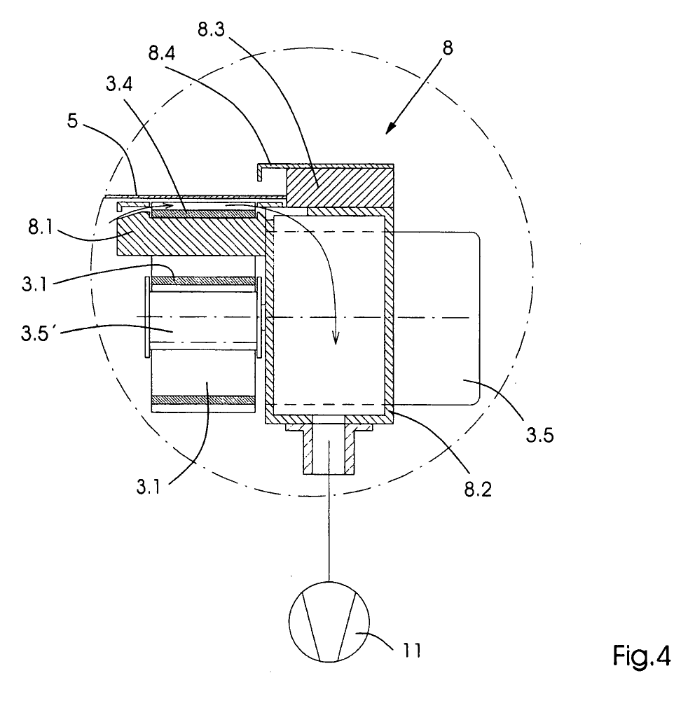

FIG. 4 shows an enlarged illustration of the detail IV in FIG. 3,

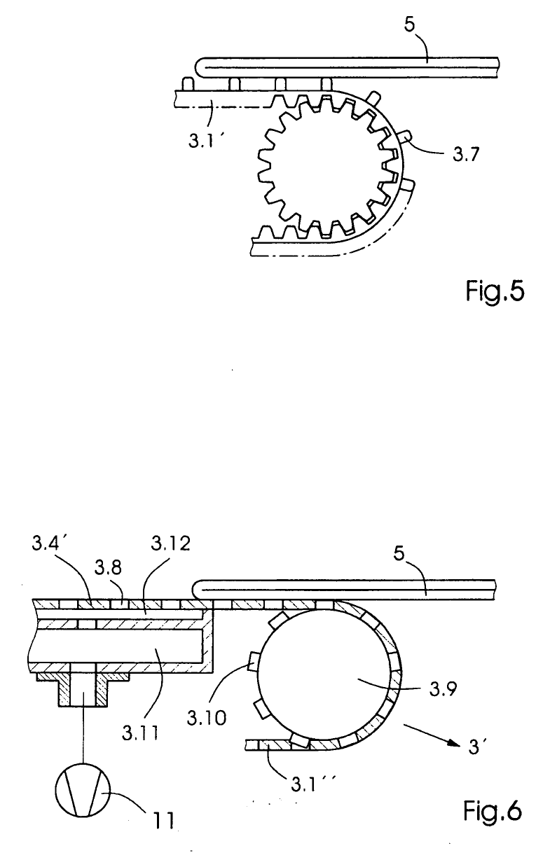

FIG. 5 shows an alternative configuration of a signature-transporting conveyor,

FIG. 6 shows a further alternative configuration of a signature-transporting conveyor, and

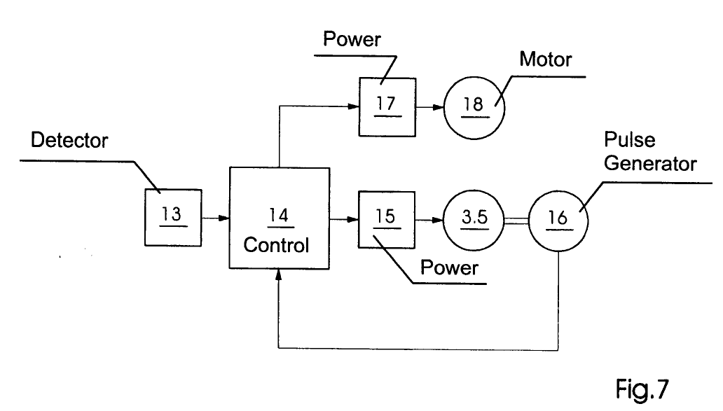

FIG. 7 shows a block diagram for a link-up of a control means with a drive, which operates the conveyor, and with a detector which detects a respective signature en route along the transporting section.

FIG. 1 represents, schematically, two folding units which follow one after the other, and are only illustrated in part in each case. A first of these folding units, in the present example, is a buckle folding unit 1, of which only a pair of folding rollers is illustrated. By means of this pair of folding rollers, signatures 5 provided with in each case at least one cross fold are transferred to a conveyor 3 in the transporting direction indicated by means of the arrow 2. This conveyor comprises a pair of endless belts 3.1 which, in the present exemplary embodiment, are designed as toothed belts with the toothing arranged on the outside of the belts 3.1. Such an arrangement of the toothing can be achieved, in particular, by virtue of a commercially available toothed belt being turned over.

A respective belt 3.1 of the pair of belts is assigned in each case to a side periphery of the signatures 5 and, in a manner which will be explained in more detail at a later stage in the text, can be adapted to the format of the signatures 5 which are to be processed.

Furthermore, a respective belt 3.1 wraps around a belt pulley 3.2, which is located upstream as seen in the transporting direction (see arrow 2) and deflects the belt 3.1, and a further, downstream belt pulley 3.3, which deflects the belt 3.1, and thus forms a conveying strand 3.4 for transporting the signatures 5 discharged from the buckle folding unit 1.

A toothed drive wheel 3.5′ of a drive 3.5 engages with the toothed outer side of the respective belt 3.1. In order to achieve an adequate angle of wrap around the drive wheel 3.5′, the latter is followed by a deflecting pulley 3.6 which deflects the belt 3.1. The belt 3.1 is thus, via a form fit, in torque-transmitting connection with the drive 3.5.

The drive 3.5 operates the conveyor 3 such that, by means of the latter, a respective signature 5 which is discharged from the buckle folding unit 1 is transported in the transporting direction, which is. specified by means of the arrow 2, along a transporting section ideally, and this will be discussed in more detail at a later stage in the text, into a processing position and, there, is kept at a standstill for processing purposes.

In the present exemplary embodiment of the apparatus, the processing involves the signatures 5 which leave the buckle folding unit 1, and have at least one cross fold, being provided with a right-angle fold. For this purpose, a downstream end portion of the conveying strand 3.4, as seen in the transporting direction in accordance with arrow 2, is assigned a blade folding unit 4, which is only illustrated in part here and has a folding blade 4.1 oriented parallel to the transporting direction. This achieves, for the abovementioned processing position, a position in which a respective signature 5 is located within the longitudinal extent of the folding blade 4.1 and, in a preferred configuration, a position in which a leading edge of the respective signature 5 and a trailing edge of the same are spaced apart equally from the longitudinal center of the folding blade 4.1.

FIG. 2 uses chain-dotted lines to represent a signature 5 in such a processing position. In this case, the lateral peripheries of the signature 5, as seen in the transporting direction, are each supported on one of the belts 3.1. The rest of the respective signature 5 is supported by a directing plate 6 with an aperture 6.1 for the through-passage of the folding blade 4.1 and scissor-type lattices 7 arranged on both sides of the directing plate.

In the case of the present exemplary embodiment, for the purpose of adapting the belts 3.1 to the format of the signatures 5, which has already been mentioned and will now be explained in more detail, the belt pulleys 3.2 and 3.3, which guide a respective belt 3.1, and the deflecting pulley 3.6 are each mounted on one of two frames 8 and 8′ which can be adjusted transversely to the transporting direction (see arrow 2). In the case of the present exemplary embodiment, a respective frame 8 or 8′ constitutes the displaceable part of a spindle drive which, in the present case, operates with two parallel spindles 9.1 which are borne in an axially fixed manner by a respective stationary side part 10 and can each be driven by means of a motor 9.2.

As can be gathered from FIGS. 2 and 3 in particular, the two frames 8 and 8′ are arranged in a mirror-inverted manner.

As can be seen in FIGS. 3 and 4 in particular, the frames 8 and 8′ comprise a guide channel 8.1 for the respective conveying strand 3.4 of the belts 3.1 and also a hollow profile 8.2 which is parallel to the guide channel and has an opening which communicates with the interspaces between the teeth of the conveying strand 3.4 of the belt 3.1, the conveying strand being guided in the guide channel 8.1. The respective hollow profile 8.2 is connected to a negative-pressure generator 11 and thus causes a respective signature 5 which is transferred to the conveyor 3, and more precisely to the conveying strands 3.4 of the belts 3.1, to be attached by suction to the conveying strands 3.4 during operation. The teeth of the toothed belts with outwardly oriented toothing constitute a profiling which is provided on the outside of a belt 3.1, through which flow can take place transversely to the longitudinal extent of the belt 3.1 and which thus makes it possible for the signatures 5 to be attached by suction to the belt 3.1. This allows the signatures to be transported without slippage.

A corresponding profiling advantageously extends along the abovementioned longitudinal extent of the belts 3.1, as is the case with turned-over toothed belts.

If use is made of toothed belts with inwardly oriented teeth, a profiling through which flow can take place transversely to the longitudinal extent of such a belt can be realized on the outside of the belt, for example, by means of protuberances. An example of this is represented in FIG. 5. With the corresponding design of the drive and of the belt pulleys and with the deflecting pulley being dispensed with, such a belt 3.1′ can be used instead of the belt 3.1 according to the exemplary embodiment of FIGS. 1 to 4.

Coming back now to FIG. 4, the latter also shows, as constituent parts of the frame 8, a straightedge 8.3, which guides the respective signature 5 laterally, and a holding-down means 8.4, which is assigned to a lateral periphery of the respective signature 5. Further holding-down means 12 are arranged on both sides of the folding blade 4.1 and extend along the directing plate 6 (see FIGS. 1 to 3).

FIG. 6 represents an alternative configuration of a conveyor 3′ which transports the signatures 5. An endless belt 3.1″, which has perforations along its length, is provided here. The perforations form a row of identical apertures 3.8 which are spaced apart at equal intervals. A drive of the conveyor 3′ comprises a belt pulley 3.9 around which the belt 3.1″ wraps in part and which has carry-along elements 3.10 which have a cross section corresponding with the apertures 3.8 and engage in the perforations, with the result that the belt 3.1″, via a form fit, is in torque-transmitting connection with a drive.

A conveying strand 3.4′ formed by the belt 3.1″ passes over a suction chamber 3.11, which is connected to a negative-pressure generator 11. On a side which is directed towards the conveying strand 3.4′, the suction chamber 3.11 has a suction groove 3.12 which is open in the direction of the conveying strand 3.4′ and communicates with the interior of the suction chamber 3.11. The suction groove 3.12 is arranged such that the interior of the suction chamber 3.11 communicates with the perforations of the belt 3.1″.

In a further alternative configuration, slippage-free transportation of the signatures 5 is realized by electrostatic charging of belts of a signature-transporting belt drive.

During operation of the apparatus, a respective signature 5 passes through a transporting section which extends from the pair of rollers of the buckle folding unit 1 at least as far as the already explained processing position and is constituted, as far as possible, by the respective conveying strand 3.4 or 3.4′ of the conveyor 3 or 3′. Arranged within this transporting section is a detector 13 which detects the leading edge and the trailing edge of a respective signature 5 en route along the transporting section. In the present exemplary embodiment, the detector 13 is inserted into the directing plate 6.

A measuring location determined by the position of the detector 13 is selected such that the respectively trailing edge of the signatures 5 has passed the same before the respective signature has reached the processing position.

As can be gathered from FIG. 7, a control means 14 is linked up to the detector 13 and—in the case of the configuration according to FIGS. 1 to 4—to the drive 3.5 of the conveyor 3. This control means can bring the drive 3.5 to a temporary standstill when the respective signature 5 reaches the processing position. The control means comprises an input unit, a processor and a memory. A power unit 15, which is connected up between the control means 14 and the drive 3.5, receives signals from the control means 14 which the latter generates in dependence on certain numbers of pulses transmitted to the control means 14 by a pulse generator 16 actuated by the drive 3.5.

If a point on the conveying strand 3.4 of the conveyor 3 covers a distance which is equal to the extent, in the transporting direction, of a sheet which is to be processed, and is still not yet folded, then the pulse generator 16 transmits, during this time, a number of pulses which correlates with this extent of the sheet. The corresponding number of pulses is stored in the memory of the control means 14 and used as a basis for a calculation which is to be carried out by the control means 14 and by way of which, taking account of the desired position of the first fold, a number of pulses Iₙₒₘᵢₙₐₗ which correlates with the extent of the signatures 5 in the transporting direction following the first folding operation in the buckle folding unit 1 is determined.

As the respective signature 5 travels into the already explained processing position, the leading edge of the signature 5 passes the detector 13. As a result, the latter transmits a first signal to the control means 14, which, on receiving the signal, starts counting the pulses transmitted by the pulse generator 16. If the trailing edge of the signature 5 then passes the detector 13, the latter transmits a second signal to the control means 14, which, in the presence of this second signal, senses the number of pulses which have been transmitted up to this point by the pulse generator 16. To this extent, a number of pulses I_{current} which correlates with the extent of the signature 5 in the transporting direction is determined by the control means in the form of an actual value. Furthermore, the control means 14 carries out a desired-value/actual-value comparison between the number of pulses Iₙₒₘᵢₙₐₗ and I_{current}. In the ideal case, which has already been mentioned and will now be picked up on again, Iₙₒₘᵢₙₐₗ and I_{current} either correspond precisely or these numbers of pulses differ from one another merely within tolerable predetermined limits, i.e. the geometry of the corresponding signature 5 lies within predetermined limits. In this case, the control means 14 brings the drive 3.5 of the conveyor 3 to a temporary standstill when the corresponding signature reaches the processing position. Once the drive 3.5 has been brought to a standstill, the control means 14 initiates processing of the corresponding signature, which is now at a standstill, i.e. the control means 14 sets a motor 18 in motion—likewise via a power unit 17—this motor, in a manner which is not illustrated specifically, driving the folding blade 4.1 in order to execute a folding displacement, with the result that the corresponding signature 5 is fed to a folding nip formed by means of a pair of folding rollers 19 assigned to the folding blade 4.1 (see FIG. 3).

The distance which a respective signature 5 has to cover, once the leading edge of the signature 5 has passed the detector 13, until it reaches the processing position is likewise stored in the form of a number of pulses in the memory of the control means 14. This distance corresponds to the spacing between the longitudinal center of the folding blade 4.1 and the detector 13 plus half the extent of the respective signature 5 in the transporting direction.

If the abovementioned ideal is not present, i.e. if a signature 5 which passes the detector 13, or the sheet which has not been folded at all, has an extent, in the transporting direction, which is outside predetermined limits, then the control means 14 does not bring the drive 3.5 to a standstill when the corresponding signature 5 reaches the processing position. Rather, such defective signatures 5 are ejected, i.e. they are transported on, by means of the conveyor 3, beyond the processing position until, finally, they leave the conveyor 3.

List of Designations

1 Buckle folding unit
2 Arrow
3; 3′ Conveyor
3.1; 3.1′; 3.1″ Belt
3.2 Belt pulley
3.3 Belt pulley
3.4; 3.4′ Conveying strand
3.5 Drive
3.5′ Drive wheel
3.6 Deflecting pulley
3.7 Protuberance
3.8 Aperture
3.9 Belt pulley
3.10 Carry-along element
3.11 Suction chamber
3.12 Suction groove
4 Blade folding unit
4.1 Folding blade
5 Signature
6 Directing plate
6.1 Aperture
7 Scissor-type lattice
8, 8′ Frame
8.1 Guide channel
8.2 Hollow profile
8.3 Straightedge
8.4 Holding-down means
9 Spindle drive
9.1 Spindle
9.2 Motor
10 Side part
11 Negative-pressure generator
12 Holding-down means
13 Detector
14 Control means
15 Power unit
16 Pulse generator
17 power unit
18 motor
19 pair of folding rollers
Iₙₒₘᵢₙₐₗ Number of pulses which correlates with the desired value of the extent of the signature 5 in the transporting direction
I_{current} Number of pulses which correlates with the actual value of the extent of the signature 5 in the transporting direction

1. An apparatus for processing preliminary products with the preliminary products at a standstill in a processing position, comprising:
a conveyor having a transporting section for transporting the preliminary products in a transporting direction along said transporting section into the processing position;
a drive operatively connected to said conveyor for moving said conveyor at least in said transporting direction;
a detector disposed at said conveyor detecting a respective one of the preliminary product en route along said transporting section; and
a control device connected to said detector and to said drive, said control device being programmed to bring said drive to a temporary standstill when the respective preliminary product reaches the processing position.

2. The apparatus according to claim 1, wherein said conveyor has at least one endless belt being in torque-transmitting connection with said drive and having a conveying strand for transporting the preliminary products.

3. The apparatus according to claim 1, wherein said conveyor has at least one endless belt in a form-fitting connection with said drive and having a conveying strand for transporting the preliminary products.

4. The apparatus according to claim 1, wherein said form-fitting connection is a torque-transmitting connection with said drive.

5. The apparatus according to claim 2, wherein said belt has:
a longitudinal extent;
an outside; and
a profiling on said outside through which flow takes place transversely to said longitudinal extent.

6. The apparatus according to claim 3, wherein said belt has:
a longitudinal extent;
an outside; and
a profiling on said outside through which flow takes place transversely to said longitudinal extent.

7. The apparatus according to claim 5, wherein said profiling is provided along an entirety of said longitudinal extent.

8. The apparatus according to claim 6, wherein said profiling is provided along an entirety of said longitudinal extent.

9. The apparatus according to claim 2, wherein:
said belt has a length and perforations along said length;
said drive has:
a belt pulley around which said belt at least partly wraps; and
carry-along elements engaging in said perforations; and
a suction chamber is associated with said conveying strand and fluidically communicates with said perforations.

10. The apparatus according to claim 3, wherein:
said belt has a length and perforations along said length;
said drive has:
a belt pulley around which said belt at least partly wraps; and
carry-along elements engaging in said perforations; and
a suction chamber is associated with said conveying strand and fluidically communicates with said perforations.

11. The apparatus according to claim 1, further comprising:
a folding tool having a folding blade;
a pair of folding rollers interacting with said folding blade for processing the signatures; and
the preliminary products are sheets to be folded to form signatures.

12. The apparatus according to claim 1, wherein:
the processing position has predetermined limits; and
said controller brings said drive to a standstill if a preliminary product reaching the processing position has a geometry lying within the predetermined limits.

13. The apparatus according to claim 1, wherein the preliminary products are graphics products.

14. An apparatus for processing preliminary products with the preliminary products at a standstill in a processing position, comprising:
a conveyor having a transporting section for transporting the preliminary products in a transporting direction along said transporting section into the processing position;
a drive operatively connected to said conveyor for moving said conveyor at least in said transporting direction;
a detector disposed at said conveyor detecting a respective one of the preliminary product en route along said transporting section; and
a means for controlling at least one of said drive (3.5 and said detector, said controlling means:
being connected to said detector and to said drive and
being configured to bring said drive to a temporary standstill when the respective preliminary product reaches the processing position.

15. The apparatus according to claim 14, wherein said conveyor has at least one endless belt being in torque-transmitting connection with said drive and having a conveying strand for transporting the preliminary products.

16. The apparatus according to claim 14, wherein said conveyor has at least one endless belt in a form-fitting connection with said drive and having a conveying strand for transporting the preliminary products.

17. The apparatus according to claim 14, wherein said form-fitting connection is a torque-transmitting connection with said drive.

18. The apparatus according to claim 15, wherein said belt has:
a longitudinal extent;
an outside; and
a profiling on said outside through which flow takes place transversely to said longitudinal extent.

19. The apparatus according to claim 16, wherein said belt has:
a longitudinal extent;
an outside; and
a profiling on said outside through which flow takes place transversely to said longitudinal extent.

20. The apparatus according to claim 19, wherein said profiling is provided along an entirety of said longitudinal extent.

21. The apparatus according to claim 19, wherein said profiling is provided along an entirety of said longitudinal extent.

22. The apparatus according to claim 15, wherein:
said belt has a length and perforations along said length;
said drive has:
a belt pulley around which said belt at least partly wraps; and
carry-along elements engaging in said perforations; and
a suction chamber is associated with said conveying strand and fluidically communicates with said perforations.

23. The apparatus according to claim 16, wherein:
said belt has a length and perforations along said length;
said drive has:
a belt pulley around which said belt at least partly wraps; and
carry-along elements engaging in said perforations; and
a suction chamber is associated with said conveying strand and fluidically communicates with said perforations.

24. The apparatus according to claim 14, further comprising:
a folding tool having a folding blade;
a pair of folding rollers interacting with said folding blade for processing the signatures; and
the preliminary products are sheets to be folded to form signatures.

25. The apparatus according to claim 14, wherein:
the processing position has predetermined limits; and
said controller brings said drive to a standstill if a preliminary product reaching the processing position has a geometry lying within the predetermined limits.

26. The apparatus according to claim 14, wherein the preliminary products are graphics products.
